(19) United States
(12) Patent Application Publication
(10) Pub. No.: US 2009/0222257 A1
(43) Pub. Date: Sep. 3, 2009

(54) SPEECH TRANSLATION APPARATUS AND COMPUTER PROGRAM PRODUCT

(76) Inventors: Kazuo SUMITA, Kanagawa (JP); Tetsuro CHINO, Kanagawa (JP); Satoshi KAMATANI, Kanagawa (JP); Kouji UENO, Shizuoka (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/388,380

(22) Filed: Feb. 18, 2009

(30) Foreign Application Priority Data
Feb. 29, 2008 (JP) 2008-049211

(51) Int. Cl. G06F 17/28

(52) U.S. Cl. 704/3

(57) ABSTRACT

A translation direction specifying unit specifies a first language and a second language. A speech recognizing unit recognizes a speech signal of the first language and outputs a first language character string. A first translating unit translates the first language character string into a second language character string that will be displayed on a display device. A keyword extracting unit extracts a keyword for a document retrieval from the first language character string or the second language character string, with which a document retrieving unit performs a document retrieval. A second translating unit translates a retrieved document into its opponent language, which will be displayed on the display device.

### CROSS-REFERENCE TO RELATED APPLICATIONS

This application is based upon and claims the benefit of priority from the prior Japanese Patent Application No. 2008-049211, filed on Feb. 29, 2008; the entire contents of which are incorporated herein by reference.

### BACKGROUND OF THE INVENTION

1. Field of the Invention

The present invention relates to a speech translation apparatus and a computer program product.

2. Description of the Related Art

In recent years, expectations have been increasing for a practical application of a speech translation apparatus that supports communication between persons using different languages as their mother tongues (language acquired naturally from childhood: first language). Such a speech translation apparatus basically performs a speech recognition process, a translation process, and a speech synthesis process in sequence, using a speech recognizing unit that recognizes speech, a translating unit that translates a first character string acquired by the speech recognition, and a speech synthesizing unit that synthesizes speech from a second character string acquired by translating the first character string.

A speech recognition system, which recognizes speech and outputs text information, has already been put to practical use in a form of a canned software program, a machine translation system using written words (text) as input has similarly been put to practical use in the form of a canned software program, and a speech synthesis system has also already been put to practical use. The speech translation apparatus can be implemented by the above-described software programs being used accordingly.

A face-to-face communication between persons having the same mother tongue may be performed using objects, documents, drawings, and the like visible to each other, in addition to speech. Specifically, when a person asks for directions on a map, the other person may give the directions while pointing out buildings and streets shown on the map.

However, in a face-to-face communication between persons having different mother tongues, sharing information using a single map is difficult. The names of places written on the map are often in a single language. A person unable to understand the language has difficulty understanding contents of the map. Therefore, to allow both persons having different mother tongues to understand the names of places, it is preferable that the names of places written on the map in one language are translated into another language and the translated names of places are presented.

In a conversation supporting device disclosed in JP-A 2005-222316 (KOKAI), a speech recognition result of a speech input from one user is translated, and a diagram for a response corresponding to the speech recognition result is presented to a conversation partner. As a result, the conversation partner can respond to the user using the diagram presented on the conversation supporting device.

However, in the conversation supporting device disclosed in JP-A 2005-222316 (KOKAI), only a unidirectional conversation can be supported.

When performing a speech-based communication, it is not preferable to involve a plurality of operations, such as searching for related documents and drawings, and instructing the device to translate the documents and drawings that have been found. Appropriate documents and drawings related to a conversation content should be preferably automatically retrieved without interfering with the communication using speech. Translation results of the retrieved documents and drawings should be presented to the speakers with different mother tongues, so that the presented documents and drawings support sharing of information.

### SUMMARY OF THE INVENTION

According to one aspect of the present invention, there is provided a speech translation apparatus including a translation direction specifying unit that specifies one of two languages as a first language to be translated and other language as a second language to be obtained by translating the first language; a speech recognizing unit that recognizes a speech signal of the first language and outputs a first language character string; a first translating unit that translates the first language character string into a second language character string; a character string display unit that displays the second language character string on a display device; a keyword extracting unit that extracts a keyword for a document retrieval from either one of the first language character string and the second language character string; a document retrieving unit that performs a document retrieval using the keyword; a second translating unit that translates a retrieved document into the second language when a language of the retrieved document is the first language, and translates the retrieved document into the first language when the language of the retrieved document is the second language, to obtain a translated document; and a retrieved document display unit that displays the retrieved document and the translated document on the display device.

Furthermore, according to another aspect of the present invention, there is provided a computer program product including a computer-usable medium having computer-readable program codes embodied in the medium. The computer-readable program codes when executed cause a computer to execute specifying one of two languages as a first language to be translated and other language as a second language to be obtained by translating the first language; recognizing a speech signal of the first language and outputting a first language character string; translating the first language character string into a second language character string; displaying the second language character string on a display device; extracting a keyword for a document retrieval from either one of the first language character string and the second language character string; performing a document retrieval using the keyword; translating a retrieved document into the second language when a language of the retrieved document is the first language, and translates the retrieved document into the first language when the language of the retrieved document is the second language, to obtain a translated document; and displaying the retrieved document and the translated document on the display device.

### BRIEF DESCRIPTION OF THE DRAWINGS

FIG. 1 is a schematic perspective view of an outer appearance of a configuration of a speech translation apparatus according to a first embodiment of the present invention;

FIG. 2 is a block diagram of a hardware configuration of the speech translation apparatus;

FIG. 3 is a functional block diagram of an overall configuration of the speech translation apparatus;

FIG. 4 is a front view of a display example;

FIG. 5 is a front view of a display example;

FIG. 6 is a flowchart of a process performed when a translation switching button is pressed;

FIG. 7 is a flowchart of a process performed when a Speak-in button is pressed;

FIG. 8 is a flowchart of a process performed for a speech input start event;

FIG. 9 is a flowchart of a process performed for a speech recognition result output event;

FIG. 10 is a flowchart of a keyword extraction process performed on English text;

FIG. 11 is a flowchart of a keyword extraction process performed on Japanese text;

FIG. 12 is a schematic diagram of an example of a part-of-speech table;

FIG. 13 is a flowchart of a topic change extracting process;

FIG. 14 is a flowchart of a process performed when a Speak-out button is pressed;

FIG. 15 is a flowchart of a process performed for a pointing event;

FIG. 16 is a flowchart of a process performed for a pointing event;

FIG. 17 is a flowchart of a process performed when a retrieval switching button is pressed;

FIG. 18 is a front view of a display example;

FIG. 19 is a block diagram of a hardware configuration of a speech translation apparatus according to a second embodiment of the present invention;

FIG. 20 is a functional block diagram of an overall configuration of the speech translation apparatus;

FIG. 21 is a flowchart of a keyword extraction process performed on Japanese text;

FIG. 22 is a schematic diagram of an example of a RFID correspondence table;

FIG. 23 is a schematic diagram of an example of a meaning category table; and

FIG. 24 is a schematic diagram of an example of a location-place name correspondence table.

### DETAILED DESCRIPTION OF THE INVENTION

Exemplary embodiments of the present invention are described in detail below with reference to the accompanying drawings. In the embodiments, a speech translation apparatus used for speech translation between English and Japanese is described with a first language in English (speech is input in English) and a second language in Japanese (Japanese is output as a translation result). The first language and the second language can be interchangeable as appropriate. Details of the present invention do not differ depending on language type. The speech translation can be applied between arbitrary languages, such as between Japanese and Chinese and between English and French.

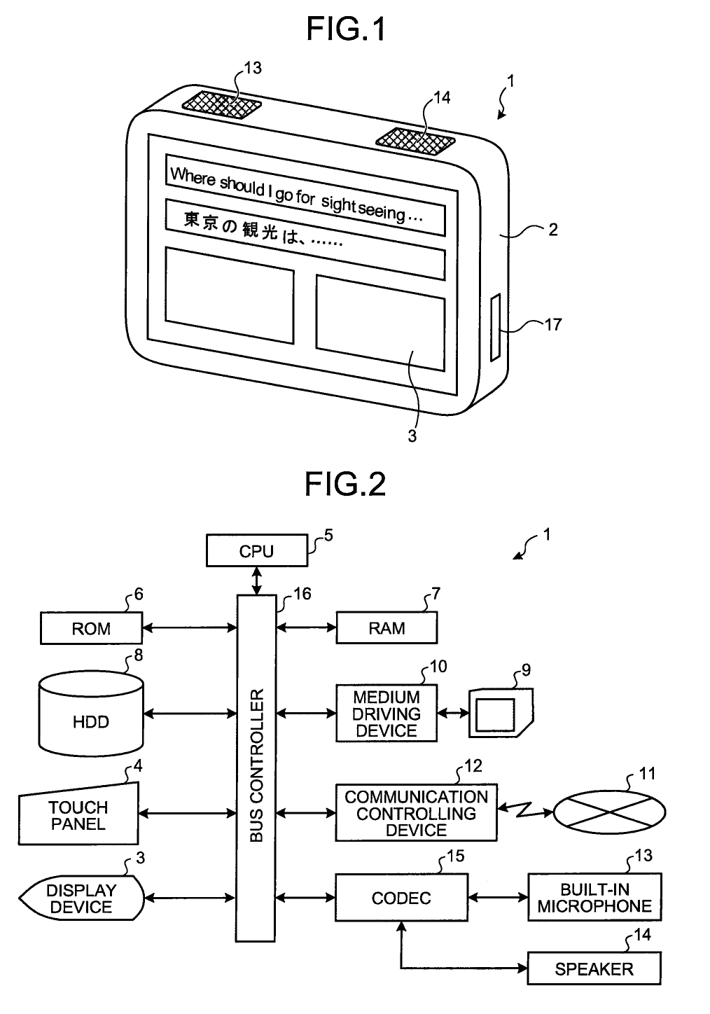

A first embodiment of the present invention will be described with reference to FIG. 1 to FIG. 18. FIG. 1 is a schematic perspective view of an outer appearance of a configuration of a speech translation apparatus 1 according to the first embodiment of the present invention. As shown in FIG. 1, the speech translation apparatus 1 includes a main body case 2 that is a thin, flat enclosure. Because the main body case 2 is thin and flat, the speech translation apparatus 1 is portable. Moreover, because the main body case 2 is thin and flat, allowing portability, the speech translation apparatus 1 can be easily used regardless of where the speech translation apparatus 1 is placed.

A display device 3 is mounted on the main body case 2 such that a display surface is exposed outwards. The display device 3 is formed by a liquid crystal display (LCD), an organic electroluminescent (EL) display, and the like that can display predetermined information as a color image. A resistive film-type touch panel 4, for example, is laminated over the display surface of the display device 3. As a result of synchronization of a positional relationship between keys and the like displayed on the display device 3 and coordinates of the touch panel 4, the display device 3 and the touch panel 4 can provide a function similar to that of keys on a keyboard. In other words, the display device 3 and the touch panel 4 configure an information input unit. As a result, the speech translation apparatus 1 can be made compact. As shown in FIG. 1, a built-in microphone 13 and a speaker 14 are provided on a side surface of the main body case 2 of the speech translation apparatus 1. The built-in microphone 13 converts the first language spoken by a first user into speech signals. A slot 17 is provided on the side surface of the main body case 2 of the speech translation apparatus 1. A storage medium 9 (see FIG. 1) that is a semiconductor memory is inserted into the slot 17.

A hardware configuration of the speech translation apparatus 1, such as that described above, will be described with reference to FIG. 2. As shown in FIG. 2, the speech translation apparatus 1 includes a central processing unit (CPU) 5, a read-only memory (ROM) 6, a random access memory (RAM) 7, a hard disk drive (HDD) 8, a medium driving device 10, a communication control device 12, the display device 3, the touch panel 4, a speech input and output CODEC 15, and the like. The CPU 5 processes information. The ROM 6 is a read-only memory storing therein a basic input/output system (BIOS) and the like. The RAM 7 stores therein various pieces of data in a manner allowing the pieces of data to be rewritten. The HDD 8 functions as various databases and stores therein various programs. The medium driving device 10 uses the storage medium 9 inserted into the slot 17 to store information, distribute information outside, and acquire information from the outside. The communication control device 12 transmits information through communication with another external computer over a network 11, such as the Internet. An operator uses the touch panel 4 to input commands, information, and the like into the CPU 5. The speech translation apparatus 1 operates with a bus controller 16 arbitrating data exchanged between the units. The CODEC 15 converts analog speech data input from the built-in microphone 13 into digital speech data, and outputs the converted digital speech data to the CPU 5. The CODEC 15 also converts digital speech data from the CPU 5 into analog speech data, and outputs the converted analog speech data to the speaker 14.

In the speech translation apparatus 1 such as this, when a user turns on power, the CPU 5 starts a program called a loader within the ROM 6. The CPU 5 reads an operating system (OS) from the HDD 8 to the RAM 7 and starts the OS. The OS is a program that manages hardware and software of a computer. An OS such as this starts a program in adherence to an operation by the user, reads information, and stores information. A representative OS is, for example, Windows (registered trademark). An operation program running on the OS is referred to as an application program. The application program is not limited to that running on a predetermined OS. The application program can delegate execution of some various processes, described hereafter, to the OS. The application program can also be included as a part of a group of program files forming a predetermined application software program, an OS, or the like.

Here, the speech translation apparatus 1 stores a speech translation process program in the HDD 8 as the application program. In this way, the HDD 8 functions as a storage medium for storing the speech translation process program.

In general, an application program installed in the HDD 8 of the speech translation apparatus 1 is stored in the storage medium 9. An operation program stored in the storage medium 9 is installed in the HDD 8. Therefore, the storage medium 9 can also be a storage medium in which the application program is stored. Moreover, the application program can be downloaded from the network 11 by, for example, the communication control device 12 and installed in the HDD 8.

When the speech translation apparatus 1 starts the speech translation process program operating on the OS, in adherence to the speech translation process program, the CPU 5 performs various calculation processes and centrally manages each unit. When importance is placed on real-time performance, high-speed processing is required to be performed. Therefore, a separate logic circuit (not shown) that performs various calculation processes is preferably provided.

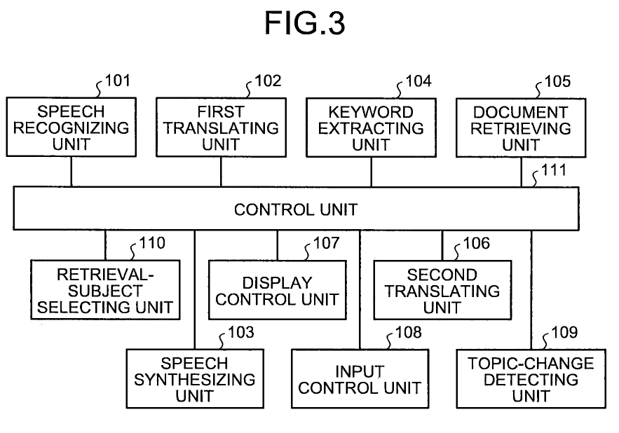

Among the various calculation processes performed by the CPU 5 of the speech translation apparatus 1, processes according to the first embodiment will be described. FIG. 3 is a functional block diagram of an overall configuration of the speech translation apparatus 1. As shown in FIG. 3, in adherence to the speech translation processing program, the speech translation apparatus 1 includes a speech recognizing unit 101, a first translating unit 102, a speech synthesizing unit 103, a keyword extracting unit 104, a document retrieving unit 105, a second translating unit 106, a display control unit 107 functioning as a character string display unit and a retrieval document display unit, an input control unit 108, a topic change detecting unit 109, a retrieval subject selecting unit 110, and a control unit 111.

The speech recognizing unit 101 generates character and word strings corresponding with speech using speech signals input from the built-in microphone 13 and the CODEC 15 as input.

In speech recognition performed for speech translation, a technology referred to as large vocabulary continuous speech recognition is required to be used. In large vocabulary continuous speech recognition, formulation of a problem deciphering an unknown speech input X to a word string W as a probabilistic process as a retrieval problem for retrieving W that maximizes p(W|X) is generally performed. In the formulation, based on Bayes' theorem, a formula is the retrieval problem for W that maximizes p(W|X) redefined as a retrieval problem for W that maximizes p(X|W)p(W). In the formulation by this statistical speech recognition, p(X|W) is referred to as a sound model and p(W) is referred to as a language model. p(X|W) is a conditional probability that is a model of a kind of sound signal corresponding with the word string W. p(W) is a probability indicating how frequently the word string W appears. A unigram (probability of a certain word occurring), a bigram (probability of certain two words consecutively occurring), a trigram (probability of certain three words consecutively occurring) and, more generally, an N-gram (probability of certain N-number of words consecutively occurring) are used. Based on the above-described formula, large vocabulary continuous speech recognition is made commercially available as dictation software.

The first translating unit 102 performs a translation to the second language using the recognition result output from the speech recognizing unit 101 as an input. The first translating unit 102 performs machine translation on speech text obtained as a result of recognition of speech spoken by the user. Therefore, the first translating unit 102 preferably performs machine translation suitable for processing spoken language.

In machine translation, a sentence in a source language (such as Japanese) is converted into a target language (such as English). Depending on a translation method, the machine translation can be largely classified into a rule-based machine translation, a statistical machine translation, and an example-based machine translation.

The rule-based machine translation includes a morphological analysis section and a syntax analysis section. The rule-based machine translation is a method that analyzes a sentence structure from a source language sentence and converts (transfers) the source language sentence to a target language syntax structure based on the analyzed structure. Processing knowledge required for performing syntax analysis and transfer is registered in advance as rules. A translation apparatus performs the translation process while interpreting the rules. In most cases, machine translation software commercialized as canned software programs and the like uses systems based on the rule-based method. In rule-based machine translation such as this, an enormous number of rules are required to be provided to actualize machine translation accurate enough for practical use. However, significant cost is incurred to manually create these rules. To solve this problem, statistical machine translation has been proposed. Subsequently, advancements are being actively made in research and development.

In statistical machine translation, formulation is performed as a probabilistic model from the source language to the target language, and a problem is formulized as a process for retrieving a target language sentence that maximizes probability. Corresponding translation sentences are prepared on a large scale (referred to as a bilingual corpus). A transfer rule for translation and a probability of the transfer rule are determined from the corpus. A translation result to which the transfer rule with the highest probability is applied is retrieved. Currently, a prototype speech translation system using statistics-based machine translation is being constructed.

The example-based machine translation uses a bilingual corpus of the source language and the target language in a manner similar to that in statistical machine translation. The example-based machine translation is a method in which a source sentence similar to an input sentence is retrieved from the corpus and a target language sentence corresponding to the retrieved source sentence is given as a translation result. In rule-based machine translation and statistical machine translation, the translation result is generated by syntax analysis and a statistical combination of pieces of translated word pairs. Therefore, it is unclear whether a translation result desired by the user of the source language can be obtained. However, in example-based machine translation, information on the corresponding translation is provided in advance. Therefore, the user can obtain a correct translation result by selecting the source sentence. However, on the other hand, for example, not all sentences can be provided as examples. Because a number of sentences searched in relation to an input sentence increases as the number of examples increase, it is inconvenient for the user to select the appropriate sentence from the large number of sentences.

The speech synthesizing unit 103 converts the translation result output from the first translating unit 102 into the speech signal and outputs the speech signal to the CODEC 15. Technologies used for speech synthesis are already established, and software for speech synthesis is commercially available. A speech synthesizing process performed by the speech synthesizing unit 103 can use these already actualized technologies. Explanations thereof are omitted.

The keyword extracting unit 104 extracts a keyword for document retrieval from the speech recognition result output from the speech recognizing unit 101 or the translation result output from the first translating unit 102.

The document retrieving unit 105 performs document retrieval for retrieving a document including the keyword output from the keyword extracting unit 104 from a group of documents stored in advance on the HDD8 that is a storage unit, a computer on the network 11, and the like. The document that is a subject of retrieval by the document retrieving unit 105 is a flat document without tags in, for example, hypertext markup language (HTML) and extensible markup language (XML), or a document written in HTML or XML. These documents are, for example, stored in a document database stored in the HDD8 or on a computer on the network 11, or stored on the Internet.

The second translating unit 106 translates at least one document that is a high-ranking retrieval result, among a plurality of documents obtained by the document retrieving unit 105. The second translating unit 106 performs machine translation on the document. The second translating unit 106 performs translation from Japanese to English and translation from English to Japanese in correspondence to a language of the document to be translated (although details are described hereafter, because the retrieval subject selecting unit 110 sets retrieval subject settings, the language corresponds to a language that is set for a retrieval subject).

When the document that is a retrieval subject of the document retrieving unit 105 is the flat document without tags in, for example, HTML and XML, each sentence in the document that is the translation subject is successively translated. The translated sentences replace the original sentences, and a translation document is generated. Because translation is successively performed by sentences, correspondence between an original document and the translation document is clear. Into which word in a translated sentence each word in the original sentence has been translated can be extracted through a machine translation process. Therefore, the original document and the translation document can be correlated in word units.

On the other hand, when the document is written in HTML and XML, machine translation is performed only on flat sentences other than the tags within the document. Translation results obtained as a result replace portions corresponding to original flat sentences, and a translation document is generated. Therefore, a translation result replacing the original flat sentence is clear. In addition, into which word in a translated sentence each word in the original sentence has been translated can be extracted through the machine translation process. Therefore, correlation between the original document and the translation document can be correlated in word units.

The display control unit 107 displays the recognition result output from the speech recognizing unit 101, the translation result output from the first translating unit 102, the translation document obtained from the second translating unit 106, and the original document that is the translation subject on the display device 3.

The input control unit 108 controls the touch panel 4. Information is input in the touch panel 4, for example, to indicate an arbitrary section in the translation document and the original document that is the translation subject, displayed on the display device 3, on which drawing is performed or that is highlighted and displayed.

The topic change detecting unit 109 detects a change in a conversation topic based on the speech recognition result output from the speech recognizing unit 101 or contents displayed on the display device 3.

The retrieval subject selecting unit 110 sets an extraction subject of the keyword extracting unit 104. More specifically, the retrieval subject selecting unit 110 sets the extraction subject of the keyword extracting unit 104 to the speech recognition result output from the speech recognizing unit 101 or the translation result output from the first translating unit 102.

The control unit 111 controls processes performed by each of the above-described units.

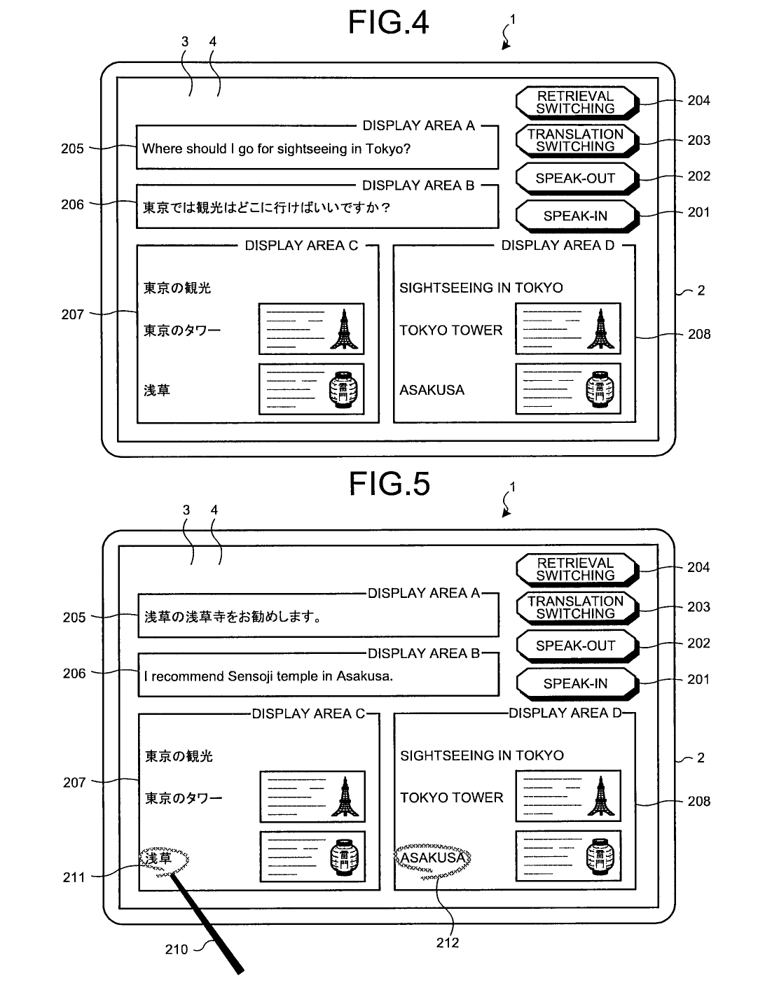

Here, to facilitate understanding, a display example of the display device 3 controlled by the display control unit 107 is explained with reference to FIG. 4 and FIG. 5. FIG. 4 and FIG. 5 show the display example of the display device 3 at different points in time.

In FIG. 4 and FIG. 5, a Speak-in button 201 instructs a start and an end of a speech input process performed through the built-in microphone 13 and the CODEC 15. When the Speak-in button 201 is pressed, speech loading starts. When the Speak-in button 201 is pressed again, speech loading ends.

A display area A 205 displays the speech recognition result output from the speech recognizing unit 101. A display area B 206 displays the translation result output from the first translating unit 102. A display area C 207 displays one document output from the document retrieving unit 105. A display area D 208 displays a result of machine translation performed by the second translating unit 106 on the document displayed in the display area C 207.

A Speak-out button 202 provides a function for converting the translation result displayed in the display area B 206 into speech signals by the speech synthesizing unit 103 and instructing output of the speech signals to the CODEC 15.

A translation switching button 203 functions as a translation direction specifying unit and provides a function for switching a translation direction for translation performed by the first translating unit 102 (switching between translation from English to Japanese and translation from Japanese to English). The translation switching button 203 also provides a function for switching a recognition language recognized by the speech recognizing unit 101.

A retrieval switching button 204 provides a function for starting the retrieval subject selecting unit 110 and switching between keyword extraction from Japanese text and keyword extraction from English text. This is based on a following assumption. When the speech translation apparatus 1 is used in Japan, for example, it is assumed that more extensive pieces of information are more likely to be retrieved when the keyword extraction is performed on Japanese text and documents in Japanese are retrieved. On the other hand, when the speech translation apparatus 1 is used in the United States, it is assumed that more extensive pieces of information are more likely to be retrieved when the keyword extraction is performed on English text and documents in English are retrieved. The user can select the language of the retrieval subject using the retrieval switching button 204.

According to the first embodiment, the retrieval switching button 204 is given is as a method of setting a retrieval subject selecting unit 220. However, the method is not limited thereto. For example, a global positioning system (GPS) can be given as a variation example other than the retrieval switching button 204. In other words, a current location on Earth is acquired by the GPS. When the current location is judged to be Japan, the retrieval subject is switched such that keyword extraction is performed on Japanese text.

In the display example shown in FIG. 4, an image is shown of an operation performed when the language spoken by the first user is English. A result of an operation performed by the speech translation apparatus 1 immediately after the first user presses the Speak-in button 201 again after pressing the Speak-in button 201 and saying, “Where should I go for sightseeing in Tokyo?”, is shown. In other words, in the display area A 205, a speech recognition result, “Where should I go for sightseeing in Tokyo?”, output from the speech recognizing unit 101 is displayed. In the display area B206, a translation result, [symbol] [symbol] [symbol] !”, output from the first translating unit 102 of the translation performed on the speech recognition result displayed in the display area A 205 is displayed. In this case, the translation switching button 203 is used to switch the translation direction to “translation from English to Japanese”. Furthermore, in the display area C 207, a document is displayed that is a document retrieval result from the document retrieving unit 105 based on a keyword for document retrieval extracted by the keyword extracting unit 104 from the speech recognition result output by the speech recognizing unit 101 or the translation result output by the first translating unit 102. In the display area D 208, a translation result output from the second translating unit 106 that is a translation of the document displayed in the display area C 207 is displayed. In this case, a retrieval subject language is switched to “Japanese” by the retrieval switching button 204.

In the display example shown in FIG. 5, an aspect in which a second user uses a pen 210 to make an indication and draw a point 211 on the retrieved document shown in the display area C 207 in the display state in FIG. 4 is shown. In the speech translation apparatus 1 according to the first embodiment, as shown in FIG. 5, when the second user uses the pen 210 to make the indication and draw the point 211 that is an emphasizing image on the retrieved document displayed in the display area C 207, a point 212 that is a similar emphasizing image is drawn on the translation result displayed in the corresponding display area D 208.

In addition, in the display example shown in FIG. 5, an image is shown of an operation performed when the language spoken by the second user is Japanese. A result of an operation performed by the speech translation apparatus 1 immediately after the second user presses the Speak-in button 201 again after pressing the translation switching button 203 to switch the translation direction to “translate from Japanese to English”, and pressing the Speak-in button 201 and saying, [symbol] [symbol] , is shown. In other words, in the display area A 205, a speech recognition result, [symbol] [symbol] , output from the speech recognizing unit 101 is displayed. In the display area B 206, a translation result, “I recommend Sensoji temple in Asakusa”, output from the first translating unit 102 of the translation performed on the speech recognition result displayed in the display area A 205 is displayed.

Next, various processes, such as those described above, performed by the control unit 111 are described with reference to flowcharts.

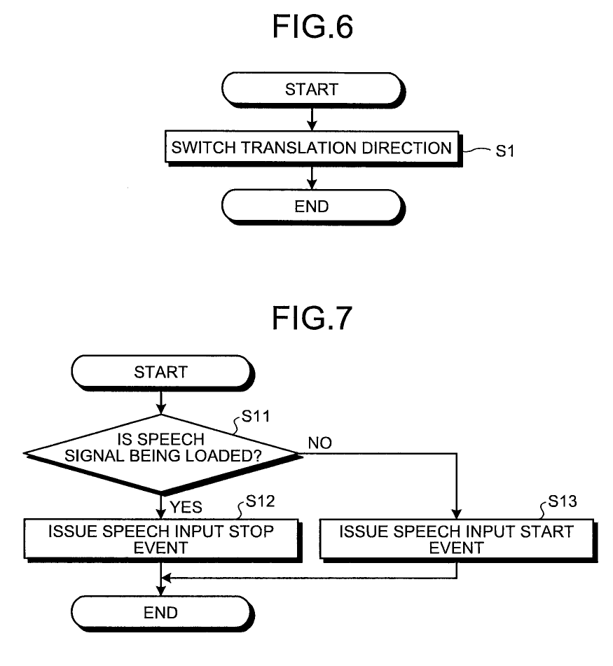

First, a process performed when the translation switching button 203 is pressed will be described with reference to a flowchart in FIG. 6. As shown in FIG. 6, when the translation switching button 203 is pressed, a translation switching button depression event is issued and the process is performed. Specifically, as shown in FIG. 6, the language recognized by the speech recognizing unit 101 is switched between English and Japanese, and the translation direction of the first translating unit 102 is switched (Step S1). For example, the recognition language of the speech recognizing unit 101 is English and the first translating unit 102 is in “translate from English to Japanese” mode when Step S1 is performed, the first translating unit 102 is switched to a mode in which Japanese speech is input and translation is performed from Japanese to English. Alternatively, when the first translating unit 102 is in “translate from Japanese to English” mode, the first translating unit 102 is switched to a mode in which English speech is input and translation is performed from English to Japanese. Initial settings of the keyword extracting unit 104 and the second translating unit 106 regarding whether the input language is English or Japanese are also switched at Step S1.

Next, a process performed when the Speak-in button 201 is pressed will be described with reference to a flowchart in FIG. 7. As shown in FIG. 7, when the Speak-in button 201 is pressed, a Speak-in button depression event is issued and the process is performed. Specifically, as shown in FIG. 7, whether a speech signal is being loaded from the built-in microphone 13 and the CODEC 15 is checked (Step S11). When the speech signal is in a loading state, it is assumed that speech is completed and a speech input stop event is issued (Step S12). On the other hand, when the speech signal is not being loaded, it is assumed that a new speech is to be spoken and a speech input start event is issued (Step S13).

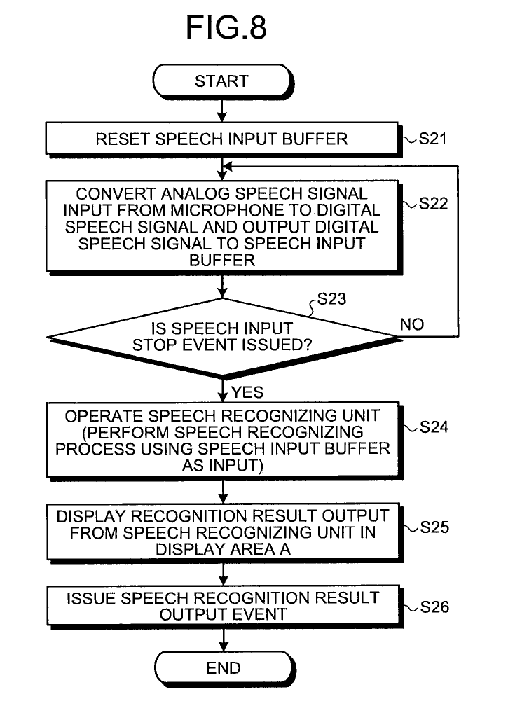

Next, a process performed for the speech input start event will be described with reference to a flowchart in FIG. 8. As shown in FIG. 8, the speech input start event (refer to Step S13 in FIG. 7) is issued and the process is performed. Specifically, as shown in FIG. 8, after a speech input buffer formed in the RAM 7 is reset (Step S21), analog speech signals input from the built-in microphone 13 are converted to digital speech signals by the CODEC 15, and the digital speech signals are output to the speech input buffer (Step S22) until the speech input stop event is received (Yes at Step S23). When the speech input is completed (Yes at Step S23), the speech recognizing unit 101 is operated and the speech recognizing process is performed with the speech input buffer as the input (Step S24). The speech recognition result acquired at Step S24 is displayed in the display area A 205 (Step S25) and a speech recognition result output event is issued (Step S26).

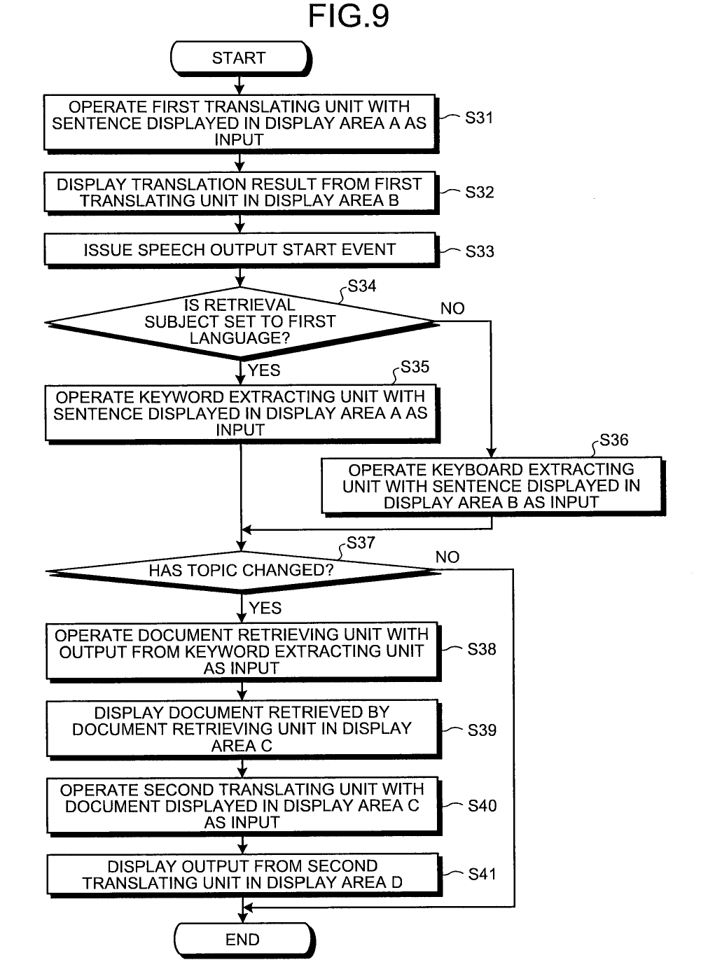

Next, a process performed for the speech recognition result output event will be described with reference to a flowchart in FIG. 9. As shown in FIG. 9, the speech recognition result output event (refer to Step S26 in FIG. 8) is issued and the process is performed. Specifically, as shown in FIG. 9, the first translating unit 102 is operated with the character string displayed in the display area A 205 as the input (Step S31). When the character string displayed in the display area A 205 is in English, the translation from English to Japanese is performed. On the other hand, when the character string is in Japanese, the translation from Japanese to English is performed. Next, the translation result acquired at Step S31 is displayed in the display area B 206 (Step S32) and a speech output start event is issued (Step S33). Next, at Step S34 to Step S36, depending on whether the retrieval subject language is Japanese or English, the keyword extracting unit 104 is performed with either the character string displayed in the display area A 205 or the character string displayed in the display area B 206 as the input.

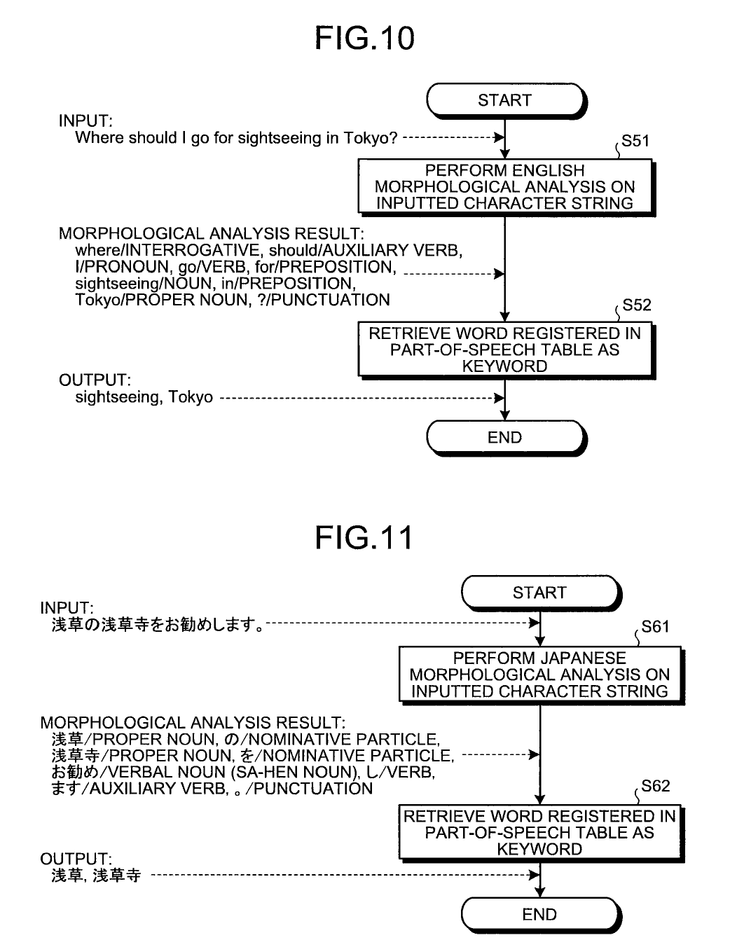

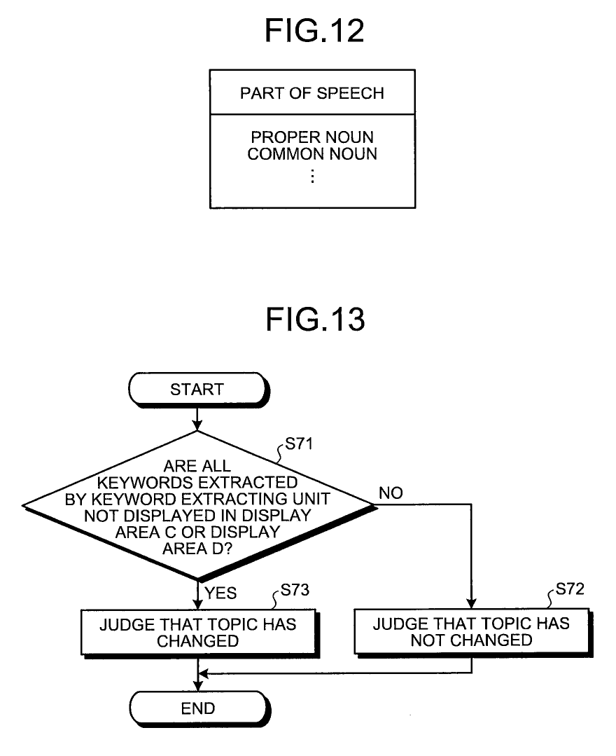

Here, FIG. 10 is a flowchart of a process performed by the keyword extracting unit 104 on English text. FIG. 11 is a flowchart of a process performed by the keyword extracting unit 104 on Japanese text. As shown in FIG. 10 and FIG. 11, the keyword extracting unit 104 performs morphological analysis on the input character string regardless of whether the character string is English text or Japanese text. As a result, a part of speech of each word forming the input character string is extracted. Then, a word registered in a part-of-speech table is extracted as a keyword. In other words, a difference between Step S51 in FIG. 10 and Step S61 in FIG. 11 is whether an English morphological analysis is performed or a Japanese morphological analysis is performed. Because part of speech information of each word forming an input text can be obtained by the morphological analysis, at Step S52 in FIG. 10 and at Step S53 in FIG. 11, the keyword is extracted with reference to the part-of-speech table based on the part of speech information. FIG. 12 is an example of a part-of-speech table referenced in the process performed by the keyword extracting unit 104. The keyword extracting unit 104 extracts the word registered to the part of speech in the part-of-speech table as the keyword. For example, as shown in FIG. 10, when “Where should I go for sightseeing in Tokyo?” is input, “sightseeing” and “Tokyo” are extracted as keywords. As shown in FIG. 11, when [symbol] [symbol] is input, [symbol] and [symbol] are extracted as the keywords.

At subsequent Step S37, based on the keywords extracted by the keyword extracting unit 104, the topic change detecting unit 109 detects whether a topic has changed during the conversation.

FIG. 13 is a flowchart of a process performed by the topic change detecting unit 109. As shown in FIG. 13, when the keywords extracted by the keyword extracting unit 104 are judged to be displayed in the display area C 207 or the display area D 208 (No at Step S71), the topic change detecting unit 109 judges that the topic has not changed (Step S72). At the same time, when all keywords extracted by the keyword extracting unit 104 are judged to not be displayed in the display area C 207 or the display area D 208 (Yes at Step S71), the topic change detecting unit 109 judges that the topic has changed (Step S73).

According to the first embodiment, a topic change is detected by the keywords extracted by the keyword extracting unit 104. However, it is also possible to detect the topic change without use of the keywords. For example, although this is not shown in FIG. 4 and FIG. 5, a clear button can be provided for deleting drawings made in accompaniment to points in the display area C 207 and the display area D 208. The drawings made in accompaniment to the points on the display area C 207 and the display area D 208 can be reset by depression of the clear button being detected. Then, the topic change detecting unit 109 can judge that the topic has changed from a state in which drawing is reset. The topic change detecting unit 109 can judge that the topic has not changed from a state in which the drawing is being made. As a result, when an arbitrary portion of the display area C 207 or the display area D 208 is indicated and a drawing is made, the document retrieval is not performed until the clear button is subsequently pressed, even when the user inputs speech. The document and the translation document shown in the display area C 207 and the display area D 208, and drawing information are held. Speech communication based on the displayed pieces of information can be performed.

When the topic change detecting unit 109 judges that the topic has not changed as described above (No at Step S37), the process is completed without changes being made in the display area C 207 and the display area D 208.

On the other hand, when the topic change detecting unit 109 judges that the topic has changed (Yes at Step S37), the document retrieving unit 105 is performed with the output from the keyword extracting unit 104 as the input (Step S38) and the document acquired as a result is displayed in the display area C 207 (Step S39). The second translating unit 106 translates the document displayed in the display area C 207 (Step S40), and the translation result is displayed in the display area D 208 (Step S41).

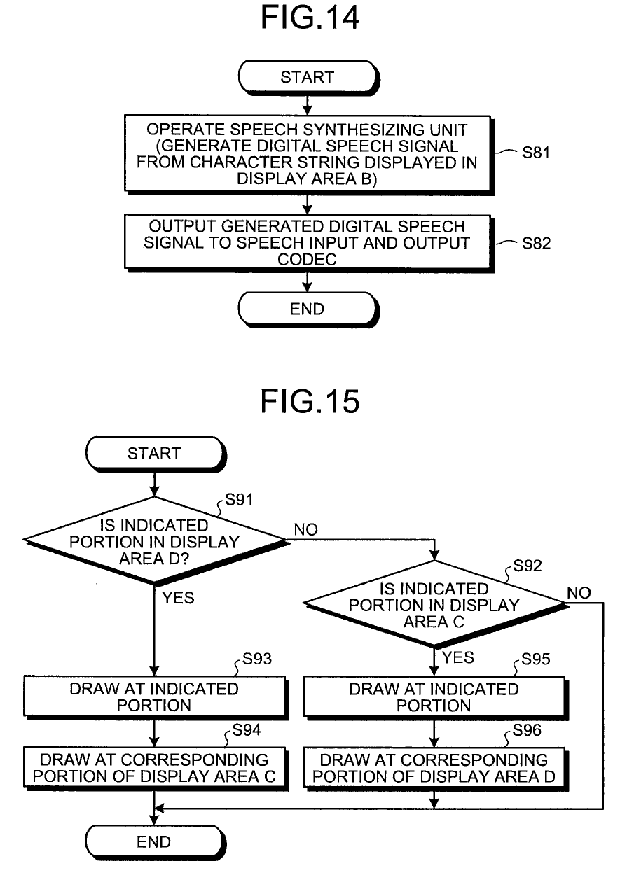

Next, a process performed when the Speak-out button 202 is pressed (or when the speech output start event is issued) will be described with reference to a flowchart in FIG. 14. As shown in FIG. 14, when the Speak-out button 202 is pressed, a Speak-out button depression event is issued and the process is performed. Specifically, as shown in FIG. 14, the speech synthesizing unit 103 is operated with the character string displayed in the display area B 206 (the translation result of the recognition result from the speech recognizing unit 101) as the input. Digital speech signals are generated (Step S81). The digital speech signals generated in this way are output to the CODEC 15 (Step S82). The CODEC 15 converts the digital speech signals to analog speech signals and outputs the analog speech signals from the speaker 14 as sound.

Next, a process performed when the user makes an indication on the touch panel 4 using the pen 210 is described with reference to the flowchart in FIG. 15. As shown in FIG. 15, a pointing event is issued from the input control unit 108 and the process is performed. Specifically, as shown in FIG. 15, when the user makes an indication on the touch panel 4 using the pen 210, whether any portion of the display area D 208 and the display area C 207 on the touch panel 4 is indicated by the pen 210 is judged (Step S91 and Step S92). When the indication is made at an area other than the display area D 208 and the display area C 207 (No at Step S91 or No at Step S92), the process is completed without any action being taken.

When a portion of the display area D 208 is indicated (Yes at Step S91), a drawing is made on the indicated portion of the display area D 208 (Step S93) and a drawing is similarly made on a corresponding portion of the display area C 207 (Step S94).

On the other hand, when a portion of the display area C 207 is indicated (Yes at Step S92), a drawing is made on the indicated portion of the display area C 207 (Step S95) and a drawing is similarly made on a corresponding portion of the display area D 208 (Step S96).

As a result of the process described above, when any portion of the display area D 208 and the display area C 207 on the touch panel 4 is indicated by the pen 210, similar points 212 (see FIG. 5) that are emphasizing images are respectively drawn on the original document acquired as a result of document retrieval displayed in the display area C 207 and the translation result displayed in the display area D 208.

To draw the emphasizing images on the corresponding portions of the display area C 207 and the display area D 208, correspondence between each position in each display area is required to be made. The correspondence between the original document and the translation document in word units can be made by the process performed by the second translating unit 106. Therefore, correspondence information regarding words can be used. In other words, when an area surrounding a word or a sentence is indicated on one display area side and the emphasizing image is drawn, because a corresponding word or sentence on the other display area side is known, the emphasizing image can be drawn in the area surrounding the corresponding word or sentence. When the documents displayed in the display area D 207 and the display area D 208 are Web documents, respective flat sentences differ, one being an original sentence and the other being a translated sentence. However, the tags, images, and the like included in the Web document are the same, including an order of appearance. Therefore, an arbitrary image in the original document and an image in the translation document can be uniformly associated through use of a number of tags present before the image, a type, a sequence, and a file name of the image. Using this correspondence, when an area surrounding an image in one display area side is indicated and a drawing is made, a drawing can be made in an area surrounding the corresponding image on the other display area side.

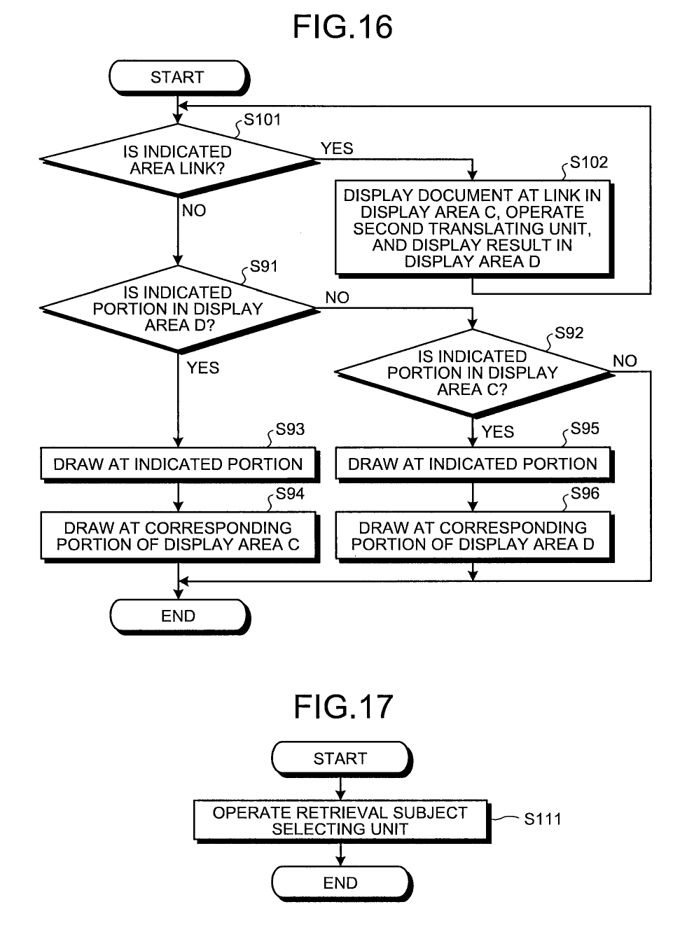

When the document to be retrieved is a Web document, the document is in hyper text expressed by HTML. In an HTML document, link information to another document is embedded in the document. The user sequentially follows a link and uses the link to display an associated document. Here, FIG. 16 is a flowchart of a process performed on the HTML document. As shown in FIG. 16, when the user makes an indication on the touch panel 4 using the pen 210 and the indicated area is a link (hyper text) (Yes at Step S101), a document at the link is displayed in the display area C 207 and the second translating unit 106 is operated. The translation result is displayed in the display area D 208 (Step S102).

A process performed when the retrieval switching button 204 is pressed will be described with reference to the flowchart in FIG. 17. As shown in FIG. 17, when the retrieval switching button 204 is pressed, a retrieval switching button depression event is issued and the process is performed. Specifically, as shown in FIG. 17, the retrieval subject selecting unit 110 is operated and the extraction subject of the keyword extracting unit 104 is set (Step S111). More specifically, the extraction subject of the keyword extracting unit 104 is set to the speech recognition result output by the speech recognizing unit 101 or the translation result output by the first translating unit 102.

According to the first embodiment, a character string in a source language acquired by speech recognition is translated into a character string in a target language, and the character string in the target language is displayed in a display device. The keyword for document retrieval is extracted from the character string in the source language or the character string in the target language. When the language of the document retrieved using the retrieved keyword is the source language, the document is translated into the target language. When the language of the retrieved document is the target language, the document is translated into the source language. The retrieved document and the document translated from the retrieved document are displayed on the display device. As a result, in communication by speech between users having different mother tongues, the document related to the conversation content is appropriately retrieved, and the translation result is displayed. As a result, the presented documents can support the sharing of information. By specification of two languages, the translation subject language and the translation language, being changed, bi-directional conversation can be supported. As a result, smooth communication can be actualized.

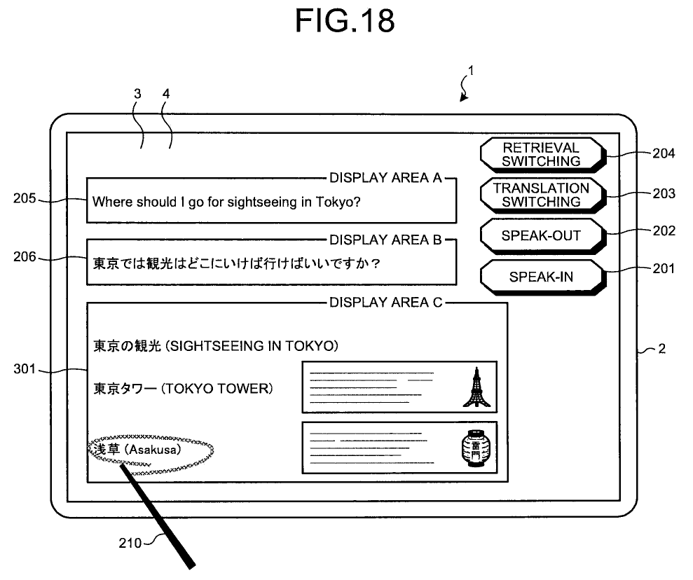

According to the first embodiment, the document retrieved by the document retrieving unit 105 is displayed in the display area C 207 and the translation document is displayed in the display area D 208. However, a display method is not limited thereto. For example, as shown in a display area 301 of an operation image in FIG. 18, translation information can be associated with sentences and words in the original document and embedded within the original document.

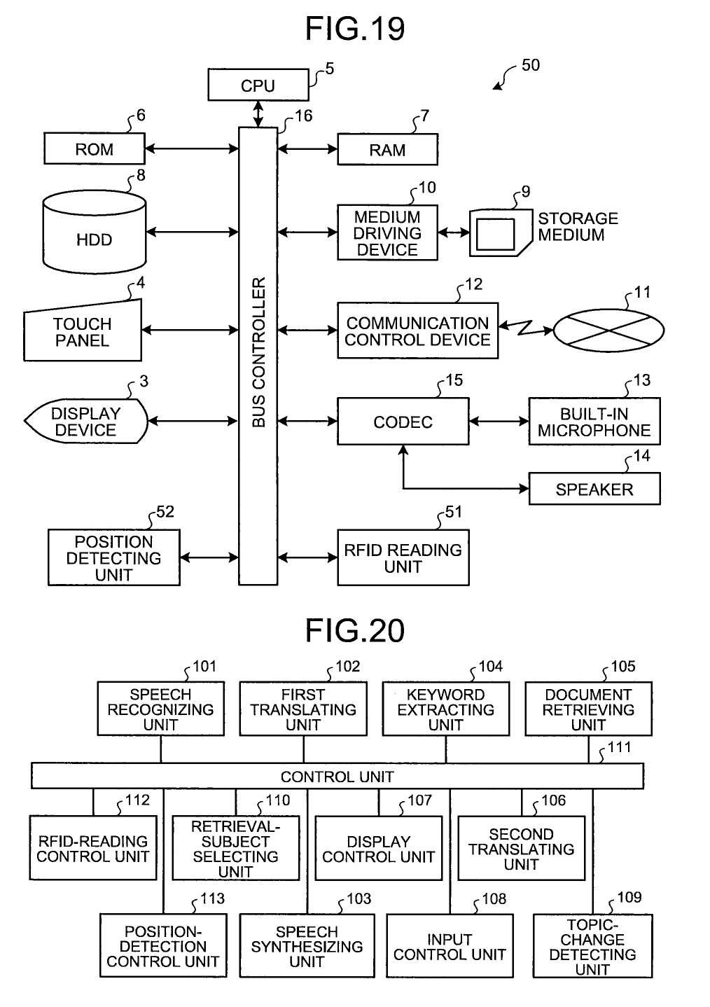

Next, a second embodiment of the present invention will be described with reference to FIG. 19 to FIG. 24. Units that are the same as those according to the above-described first embodiment are given the same reference numbers.

Explanations thereof are omitted.

According to the second embodiment, the present invention can be applied to conversations related to an object present at a scene, such as [symbol] [symbol] [symbol] ?”, or conversations related to a place, such as [symbol] [symbol] ?”, in which the place cannot be identified by only keywords extracted from a sentence.

FIG. 19 is a block diagram of a hardware configuration of a speech translation apparatus 50 according to the second embodiment of the present invention. As shown in FIG. 19, in addition to the configuration of the speech translation apparatus 1 described according to the first embodiment, the speech translation apparatus 50 includes a radio-frequency identification (RFID) reading unit 51 that is a wireless tag reader and a location detecting unit 52. The RFID reading unit 51 and the location detecting unit 52 are connected to the CPU 5 by a bus controller 16.

The RFID reading unit 51 reads a RFID tag that is a wireless tag attached to a dish served in a restaurant, a product sold in a store, and the like.

The location detecting unit 52 is generally a GPS, which detects a current location.

FIG. 20 is a functional block diagram of an overall configuration of the speech translation apparatus 50. As shown in FIG. 20, the speech translation apparatus 50 includes, in addition to the speech recognizing unit 101, the first translating unit 102, the speech synthesizing unit 103, the keyword extracting unit 104, the document retrieving unit 105, the second translating unit 106, the display control unit 107, the input control unit 108, the topic change detecting unit 109, the retrieval subject selecting unit 110, and the control unit 111, an RFID reading control unit 112 and a location detection control unit 113.

The RFID reading control unit 112 outputs information stored on the RFID tag read by the RFID reading unit 51 to the control unit 111.

The location detection control unit 113 outputs positional information detected by the location detecting unit 52 to the control unit 111.

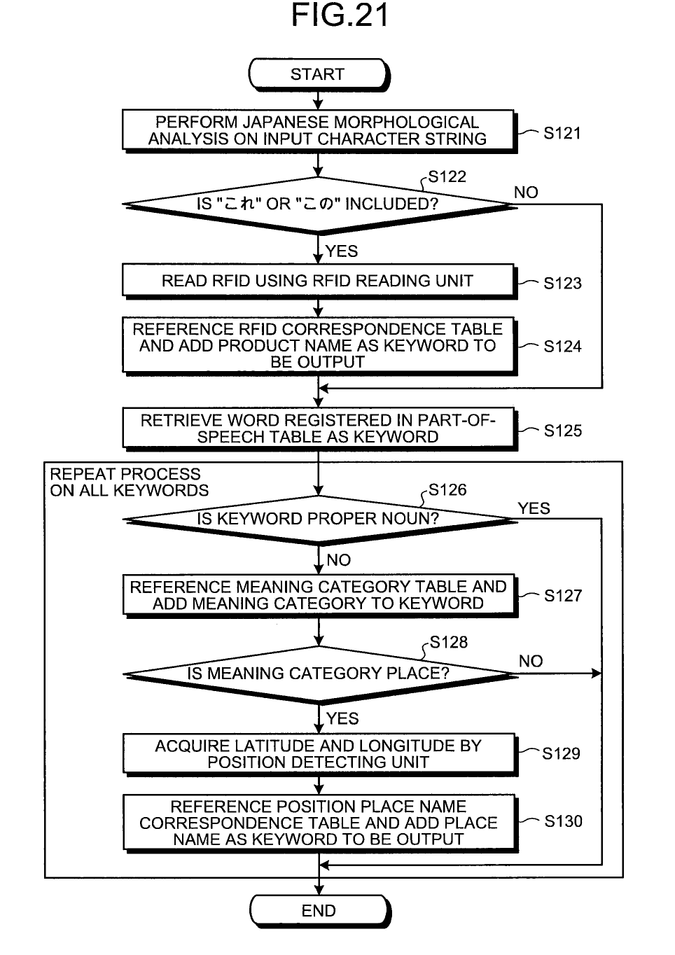

In the speech translation apparatus 50, the keyword extracting process differs from that of the speech translation apparatus 1 according to the first embodiment. The process will therefore be described. FIG. 21 is a flowchart of the keyword extracting process performed on Japanese text. Here, the keyword extracting process performed on Japanese text will be described. However, the keyword extracting process can also be performed on English text and the like. As shown in FIG. 21, the keyword extracting unit 104 first performs a Japanese morphological analysis on an input character string (Step S121). As a result, a part of speech of each word in the input character string is extracted. Next, whether a directive (proximity directive) indicating an object near the speaker, such as [symbol] and [symbol] , is included among extracted words is judged (Step S122).

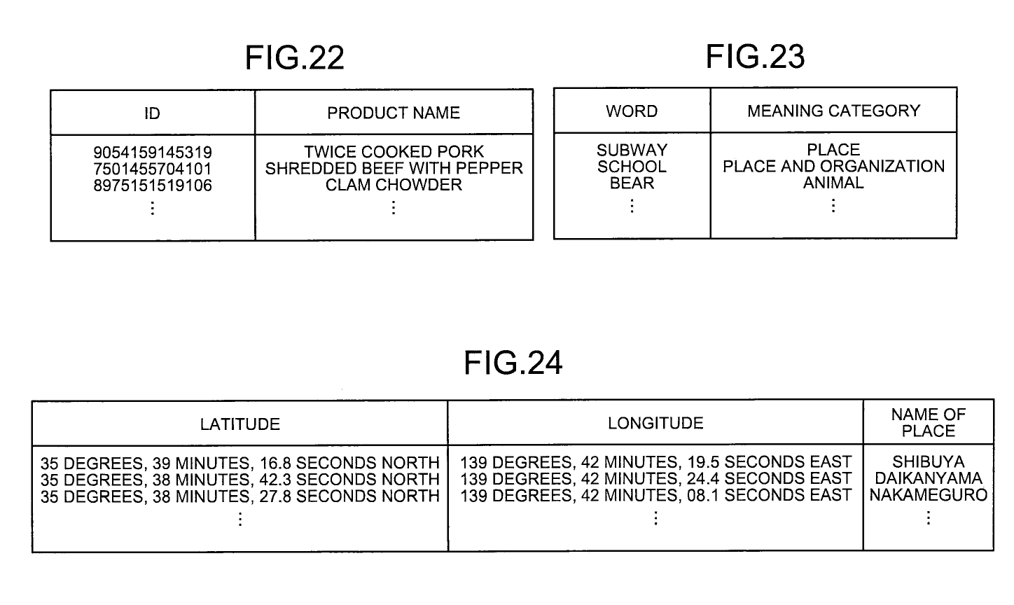

When [symbol] or [symbol] is judged to be included (Yes at Step S122), the RFID reading control unit 112 controls the RFID reading unit 51 and reads the RFID tag (Step S123). The RFID reading control unit 112 references a RFID correspondence table. If a product name corresponding to information stored on the read RFID tag is found, the product name is added as a keyword to be output (Step S124). For example, as shown in FIG. 22, information stored on a RFID tag (here, a product ID) and a product name are associated, and the association is stored in the RFID correspondence table.

Subsequently, the keyword extracting unit 104 extracts the word registered in the part-of-speech table (see FIG. 12) as the keyword (Step S125).

On the other hand, [symbol] or [symbol] is judged not to be included (No at Step S122), a process at Step S125 is performed without the information on the RFID tag being read. Keyword extraction is then performed.

Processes performed at subsequent Step S126 to Step S130 are repetitive processes processing all keywords extracted at Step S125. Specifically, whether the keyword is a proper noun is judged (Step S126). When the keyword is not a proper noun (No at Step S126), a meaning category table is referenced, and a meaning category is added to the keyword (Step S127). For example, as shown in FIG. 23, a word and a meaning category indicating a meaning or a category of the word are associated, and the association is stored in the meaning category table.

Here, when the meaning category is [symbol] or, in other words, the word is a common noun indicating place (Yes at Step S128), the location detection control unit 113 controls the location detecting unit 52 and acquires a longitude and a latitude (Step S129). The location detection control unit 113 references a location-place name correspondence table and determines a closest name of place (Step S130). For example, as shown in FIG. 24, the name of place is associated with the longitude and the latitude, and the association is stored in the location-place name correspondence table.

As a result of the keyword extracting process, in a speech using a proximity directive that is [symbol] , such as in [symbol] [symbol] [symbol] ?”, because the RFID tag is attached to dishes and the like served in a restaurant and the RFID tag is attached to products sold at stores, when a conversation related to a dish or a product is made, a more preferable retrieval of a related document can be performed through use of the keyword based on the information stored on the RFID tag. Moreover, when a conversation is related to a place, such as [symbol] [symbol] ?”, a suitable document cannot be retrieved through use of only the keywords “subway” and “station”. However, by a location of the user being detected and a name of place near the location being used, a more suitable document can be retrieved.

As described above, the speech translation apparatus according to each embodiment is suitable for smooth communication because, in a conversation between persons with different languages as their mother tongues, an appropriate related document can be displayed in each mother tongue and used as supplementary information for a speech-based conversation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A speech translation apparatus comprising:
a translation direction specifying unit that specifies one of two languages as a first language to be translated and other language as a second language to be obtained by translating the first language;
a speech recognizing unit that recognizes a speech signal of the first language and outputs a first language character string;
a first translating unit that translates the first language character string into a second language character string;
a character string display unit that displays the second language character string on a display device;
a keyword extracting unit that extracts a keyword for a document retrieval from either one of the first language character string and the second language character string;
a document retrieving unit that performs a document retrieval using the keyword;
a second translating unit that translates a retrieved document into the second language when a language of the retrieved document is the first language, and translates the retrieved document into the first language when the language of the retrieved document is the second language, to obtain a translated document; and
a retrieved document display unit that displays the retrieved document and the translated document on the display device.

2. The speech translation apparatus according to claim 1, further comprising:
a retrieval selecting unit that selects either one of the first language character string and the second language character string as a subject for the document retrieval, wherein
the keyword extracting unit extracts the keyword from either one of the first language character string and the second language character string selected as the subject for the document retrieval by the retrieval selecting unit.

3. The speech translation apparatus according to claim 1, wherein
the keyword is a word of a predetermined part of speech.

4. The speech translation apparatus according to claim 1, wherein
the retrieved document display unit embeds the translated document in the retrieved document.

5. The speech translation apparatus according to claim 1, further comprising:
an input control unit that receives an input of a position of either one of the retrieved document and the translated document displayed on the display device, wherein
the retrieved document display unit displays an emphasizing image on both the retrieved document and the translated document corresponding to the position.

6. The speech translation apparatus according to claim 1, further comprising:
an input control unit that receives an input of a position of either one of the retrieved document and the translated document displayed on the display device, wherein
when a link is set at the position, the retrieved document display unit displays a document of the link.

7. The speech translation apparatus according to claim 1, further comprising:
a topic change detecting unit that detects a change of a topic of a conversation, wherein
the document retrieving unit retrieves a document including the keyword extracted by the keyword extracting unit when the topic change detecting unit detects the change of the topic.

8. The speech translation apparatus according to claim 7, wherein
the retrieved document display unit further displays the keyword extracted by the keyword extracting unit on the display device, and
the topic change detecting unit determines that the topic has been changed when the keyword extracted by the keyword extracting unit is not displayed.

9. The speech translation apparatus according to claim 7, further comprising:
an input control unit that receives an input of a position of either one of the retrieved document and the translated document displayed on the display device, wherein
the retrieved document display unit displays an emphasizing image on both the retrieved document and the translated document corresponding to the position, and
the topic change detecting unit determines that the topic has been changed when the emphasizing image is reset.

10. The speech translation apparatus according to claim 1, further comprising:
a location detecting unit that detects a current location of a user, wherein
when the extracted keyword is a common noun indicating a place, the keyword extracting unit acquires the current location from the location detecting unit and extracts a name of place of the current location as the keyword.

11. The speech translation apparatus according to claim 1, further comprising:
a wireless tag reading unit that reads a wireless tag, wherein
when an extracted keyword is a directive indicating a nearby object, the keyword extracting unit acquires information stored in the wireless tag from the wireless tag reading unit and extracts a noun corresponding to acquired information as the keyword.

12. A computer program product comprising a computer-usable medium having computer-readable program codes embodied in the medium that when executed cause a computer to execute:
specifying one of two languages as a first language to be translated and other language as a second language to be obtained by translating the first language;
recognizing a speech signal of the first language and outputting a first language character string;
translating the first language character string into a second language character string;
displaying the second language character string on a display device;
extracting a keyword for a document retrieval from either one of the first language character string and the second language character string;
performing a document retrieval using the keyword;
translating a retrieved document into the second language when a language of the retrieved document is the first language, and translates the retrieved document into the first language when the language of the retrieved document is the second language, to obtain a translated document; and
displaying the retrieved document and the translated document on the display device.
